(19) United States
(12) Patent Application Publication
(10) Pub. No.: US 2015/0259527 A1
(43) Pub. Date: Sep. 17, 2015

(54) RESIN COMPOSITION AND RESIN MOLDED ARTICLE

(71) Applicant: FUJI XEROX CO., LTD., Tokyo (JP)

(72) Inventors: Kenji YAO, Kanagawa (JP); Masahiro MORIYAMA, Kanagawa (JP); Masato MIKAMI, Kanagawa (JP)

(21) Appl. No.: 14/444,471

(22) Filed: Jul. 28, 2014

(30) Foreign Application Priority Data
Mar. 12, 2014 (JP) 2014-049328

(51) Int. Cl. C08L 69/00; C08L 1/12

(52) U.S. Cl. CPC C08L 69/00; C08L 1/12

(57) ABSTRACT

A resin composition includes a cellulose derivative represented by the following formula (1), a polycarbonate, an ABS resin, and a phosphate:

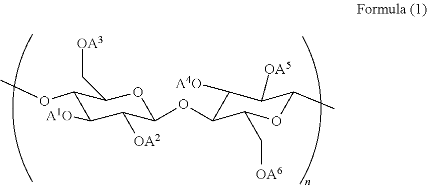

wherein A¹, A², A³, A⁴, A⁵, and A⁶ each independently represent a hydrogen atom or an acyl group, and n represents an arbitrary integer.

### CROSS-REFERENCE TO RELATED APPLICATIONS

This application is based on and claims priority under 35 USC 119 from Japanese Patent Application Ho. 2014-049328 filed Mar. 12, 2014.

### BACKGROUND

1. Technical Field

The present invention relates to a resin composition and a resin molded article.

2. Related Art

In the related art, various resin compositions are provided and are used to prepare various resin molded articles.

### SUMMARY

According to an aspect of the invention, there is provided a resin composition including;

a cellulose derivative represented by the following formula (1);

a polycarbonate;

an ABS resin;and

a phosphate;

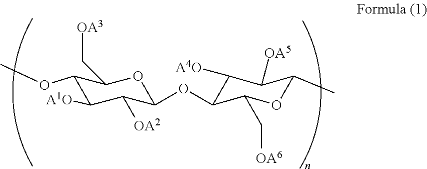

wherein A¹, A², A³, A⁴, A⁵, and A⁶ each independently represent a hydrogen atom or an acyl group, and n represents an arbitrary integer.

### DETAILED DESCRIPTION

Hereinafter, exemplary embodiments of the invention will be described. The description and examples of the exemplary embodiments are merely exemplary and do not limit the scope of the invention.

In this specification, in a case where plural kinds of materials corresponding to each component are present in a composition, the amount of each component in the composition refers to, unless specified otherwise, the total amount of the plural kinds of materials present in the composition.

### Resin Composition

A resin composition according to an exemplary embodiment of the invention contains a cellulose derivative (also simply referred to as “cellulose derivative”) represented, by the following formula (1), a polycarbonate, an ABS resin, and a phosphate.

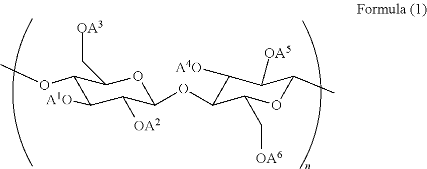

### Formula (1)

In the formula (1), A¹, A², A³, A⁴, A⁵, and A⁶ each independently represent a hydrogen atom or an acyl group, and n represents an arbitrary integer.

When a molded article is prepared from the resin composition according to the exemplary embodiment, impact resistance and flame retardance are superior due to the above-described configuration. In addition, the resin composition according to the exemplary embodiment has satisfactory fluidity and thus may be suitably applied to a molding method such as injection molding in which fluidity is required.

A presumption on a mechanism of the above configuration will foe described below.

Since a cellulose derivative is highly combustible, a resin composition containing a cellulose derivative is poor in flame retardance. For the purpose of imparting flame retardance to a resin molded article containing a cellulose derivative, an attempt to add a phosphate (including a condensed phosphate) thereto as a flame retardant has been made. However, since the affinity between the cellulose derivative and the phosphate is low, flame retardance is difficult to improve.

When a polycarbonate is mixed with, a cellulose derivative and a phosphate is added thereto, the phosphate is selectively dispersed in the polycarbonate, and the formation of a char layer of the polycarbonate is accelerated during contact with flames. As a result, flame retardance may be improved.

However, by the phosphate being selectively dispersed, the impact resistance of the polycarbonate is decreased. As a result, the impact resistance of the entire resin molded article is decreased.

Further, the phases of the cellulose derivative and the polycarbonate are easily separated. Accordingly, the fluidity of a resin composition containing both the cellulose derivative and the polycarbonate is likely to be decreased and thus may be poor in moldabiiity.

On the other hand, when an ABS resin is mixed with a cellulose derivative and a phosphate is added thereto, the fluidity of the resin composition and the impact resistance and the flame retardance ox a molded article prepared from the resin composition are improved. As a result, a resin composition and a resin molded article having a relatively good balance may be obtained. However, the above resin composition does not have sufficient fluidity, impact resistance, and flame retardance and is used only for manufacturing a relatively small component.

The present inventors nave found that a resin avoided article containing a cellulose derivative, a polycarbonate, an ABS resin, and a phosphate exhibits high impact resistance and flame retardance and have satisfactory fluidity during molding. A mechanism of this configuration is presumed to be that the phosphate is selectively dispersed in the ABS resin as compared to the polycarbonate to suppress a decrease in the impact resistance of the polycarbonate, and thus high impact resistance may be exhibited. In addition, it is presumed that the ABS resin has nigh affinity to both the cellulose derivative and the polycarbonate and thus is uniformly dispersed in the resin molded article; as a result, the phosphate is uniformly dispersed in the entirety of the resin molded article, and high flame retardance may be exhibited. Further, it is presumed that, since the ABS resin suppresses phase separation between the cellulose derivative and the polycarbonate, fluidity is high.

It is preferable that the resin composition according to the exemplary embodiment contain at least one of a cellulose derivative and a polycarbonate as a major component. The major component according to the exemplary embodiment refers to a component having the highest content (in terms of weight) among components contained in the resin composition.

According to an aspect of the resin composition of the exemplary embodiment, the content of the cellulose derivative is more than that of the polycarbonate, and a content ratio (cellulose derivative/polycarbonate, weight ratio) of both the components is from 2.3 to 15. In this aspect, when the content ratio is 2.3 or higher, the dispersibility of the polycarbonate to the cellulose derivative is high, and thus all the properties including the moldability of the resin composition and the impact resistance and the flame retardance of a molded article prepared from the resin composition are likely to be high. On the other hand, in the aspect, when the content ratio is 15 or lower, the flame retardance of a avoided article prepared from the resin composition, is likely to be high.

From the above-described viewpoints, the content ratio is more preferably from 2.3 to 9 and still more preferably from 2.3 to 3.

According to another preferable aspect of the resin composition of the exemplary embodiment, the content of the polycarbonate is more than that of the cellulose derivative, and a content ratio (cellulose derivative/polycarbonate, weight ratio) of both the components is from 0.1 to 0.5. In this aspect, when the content ratio is 0.1 or higher, the impact resistance of a molded article prepared from the resin composition is likely to he high. On the other hand, in this aspect, when the content ratio is 0.5 or lower, the dispersibility of the cellulose derivative to the polycarbonate is high, and thus all the properties including the moldability of the resin composition and the impact resistance and the flame retardance of a molded article prepared from the resin composition are likely to be high.

From the above-described viewpoints, the content ratio is more preferably from 0.2 to 0.35.

In the resin composition according to the exemplary embodiment, a content ratio (cellulose derivative/ABS resin, weight ratio) of the cellulose derivative to the ABS resin is preferably from 4 to 20.

When the content ratio is 4 or higher, the content of the cellulose derivative is sufficient with respect to the content of the ABS resin. Therefore, the ABS resin has high affinity to the cellulose derivative, and the flame retardance of a molded article prepared from the resin composition is likely to be high.

On the other hand, when the content ratio is 20 or lower, the content of the ABS resin which is a dispersoid of the phosphate is appropriate with respect to the content of the cellulose derivative. Therefore, the amount of the phosphate transferred to the polycarbonate is small, the impact resistance of the polycarbonate is maintained, and the impact resistance of a molded article prepared from the resin composition is likely to be high.

From the above-described viewpoints, the content ratio is more preferably from 5 to 20 and still more preferably from 5 to 15.

In the resin composition according to the exemplary embodiment, a ratio ((cellulose derivative * polycarbonate)/ABS resin, weight ratio) of the total content of the cellulose derivative and the polycarbonate to the content of the ABS resin is preferably from 6 to 30.

When the content ratio is 6 or higher, the total content of the cellulose derivative and the polycarbonate, which arc a substrate to which the ABS resin has affinity, is sufficient with respect to the content of the ABS resin. Therefore, the flame retardance of a molded article prepared from the resin composition is likely to be high.

On the other hand, when the content ratio is 30 or lower, the content of the ABS resin which is a dispersoid of the phosphate is appropriate with respect to the total content of the cellulose derivative and the polycarbonate. Therefore, the amount of the phosphate transferred to the polycarbonate is small, the impact resistance of the polycarbonate is maintained, and the impact resistance of a molded article prepared from the resin composition is likely to be high.

From the above-described viewpoints, the content ratio is more preferably from 7 to 25.

Hereinafter, the components of the resin composition according to the exemplary embodiment will be described in detail.

Cellulose Derivative

The resin composition according to the exemplary embodiment contains the cellulose derivative represented by the formula (1). It is preferable that the cellulose derivative have high affinity to the ABS resin. When the affinity to the ABS resin is high, an effect of improving ail the properties including the moldability of the resin composition and the impact, resistance and the flame retardance of a molded article prepared from the resin composition is high.

In the formula (1), A¹ to A² each independently represent a hydrogen atom or an acyl group. Among n number of A¹ present in the cellulose derivative molecule, ail the A¹ may be the same, or a part of A¹ may be the same or A¹ may be different from each other. The same shall be applied to n number of A², n number of A³, n number of A⁴, n number of A⁵, and n number of A⁵.

In the cellulose derivative represented by the formula (1), it is preferable that at least a part of hydroxyl groups of cellulose be acylated. The acylation degree of the cellulose derivative according to the exemplary embodiment is expressed by the average number (hereinafter, referred to as “substitution degree”) of intramolecular substitutions of three hydroxyl groups in D-glucopyranose unit. In the exemplary embodiment, the substitution degree is preferably from 2.0 to 2.9. When the substitution degree is 2.0 or more, an intermolecular interaction between cellulose derivatives is alleviated, and the fluidity of the resin composition is further improved. On the other hand, when the substitution degree is 2.0 or less, the affinity to the ABS resin is high. From the above-described, viewpoints, the substitution degree is more preferably from 2.2 to 2.5.

Examples of the acyl group represented by A¹ to A⁶ in the formula (1) include a formyl group, an acetyl group, a propionyl group, and a benzoyl group. As the acyl group, an acetyl group or a propionyl group is preferable, and an acetyl group is more preferable from the viewpoint of the high affinity to the ABS resin.

From the viewpoint of the high affinity to the ABS resin, acetyl cellurose having the acetyl substitution degree of from 2.2 to 2.5 is preferable as the cellulose derivative.

In the formula (1), n represents an arbitrary integer. A range of n is not particularly limited but, for example, is from 200 to 750 and preferably from 350 to 500.

The weight average molecular weight of the cellulose derivative is, for example, from 100,000 to 300,000 and preferably from 150,000 to 200,000.

A ratio of the weight of the cellulose derivative to the total weight of the resin composition is preferably 8% by weight to 85% by weight, When the ratio of the weight of the cellulose derivative is 8% by weight or higher, the impact resistance of a molded article prepared from the resin composition is higher. On the other hand, when the ratio of the weight of the cellulose derivative is 85% by weight or lower, the flame retardance of a molded article prepared from the resin composition is higher. From the viewpoint described above, the ratio of the weight of the cellulose derivative is more preferably 10% by weight to 80% by weight, still raore preferably 10% by weight to 75% by weight, and even still more preferably from 20% by weight to 70% by weight.

### Polycarbonate

The resin composition according to the exemplary embodiment contains the polycarbonate. The polycarbonate is a polymer obtained using a phosgene method in which a dihydroxy diallyl compound and a phosgene are allowed to react with each other or an ester exchange method in which a dihydroxy diaryl compound and a carbonate such as a diphenyl carbonate are allowed to react with each other. These polymers may be used alone or in combination of two or more hinds.

Examples of the dihydroxy diaryl compound used as a polymerization component of the polycarbonate include bis(hydroxyaryl)alkanes such as 2,2-bis(4-hydroxyphenyl)propane (that is, bisphenol A), bis(4-hydroxyphenyl)methane, 1,1-bis(4-hydroxyphenyl)ethane, 2,2-bis(4-hydroxyphenyl)butane, 2,2-bis(4-hydroxyphenyl)octane, bis(4-hydroxyphenyl)phenylmethane, 2,2-bis(4-hydroxyphenyl-3-methylphenyl)propane, 1,1-bis(4-hydroxy-3-t-butylphenyl)propane, 2,2-bis(4-hydroxy-3-bromophenyl)propane, 2,2-bis(4-hydroxy-3,5-dibromophenyl)propane, and 2,2-bis(4-hydroxy-3,5-dichlorophenyl)propane; bis(hydroxyaryl)cycloalkanes such as 1,1-bis(4-hydroxyphenyl)cyclopentane and 1,1-bis(4-hydroxyphenyl)cyclohexane; dihydroxydiaryl ethers such as 4,4′-dihydroxydiphenyl ether and 4,4′-dihydroxy-3,3′-dimethyldiphenyl ether; dihydroxydiaryl sulfides such as 4,4′-dihydroxydiphenyl sulfide; dihydroxydiaryl sulfoxides such as 4,4′-dihydroxydiphenyl sulfoxide and 4,4′-dihydroxy-3,3′-dimethyldiphenyl sulfoxide; and dihydroxydiaryl sulfones such as 4,4′-dihydroxydiphenyl sulfone and 4,4′-dihydroxy-3,3′-dimethyldiphenyl sulfone. These dihydroxydiaryl compounds may be mixed with a trivalent or higher valent phenol compound.

The weight average molecular weight of the polycarbonate is, for example, from 15,000 to 50,000 and preferably from 20,000 to 40,000.

A ratio of the weight of the polycarbonate to the total-weight of the resin composition is preferably 5% by weight to 80% by weight. When the ratio of the weight of the polycarbonate is 5% by weight or higher, the flame retardance of a molded article prepared from the resin composition is higher. On the other hand, when the ratio of the weight of the polycarbonate is 80% by weight or lower, the impact resistance of a molded article prepared from the resin composition is higher. Prom the above-described viewpoints, the ratio of the weight of the polycarbonate is more preferably from 10% by weight to 70% by weight.

### ABS Resin

The resin composition according to the exemplary embodiment contains the ABS resin. The kind of the ABS resin is not particularly limited, and the ABS resin may be prepared using a grafting method or a polymer blending method. The ABS resin may be used alone or in combination of two or more kinds.

The content of acrylonitrile in the ABS resin is, for example, from 10% by weight to 60% by weight, and the concent of butadiene in the ABS resin is, for example, from 5% by weight to 30% by weight.

The melt flow rate (g/10 min) of the ABS resin at 220° C. and at a load of 10 kg is, for example, from 5 to 200 and preferably from 15 to 100.

A ratio of the weight of the ABS resin to the total weight of the resin composition is preferably 3% by weight to 10% by weight. When the ratio of the weight of the ABS resin is 3% by weight or higher, the impact resistance of a molded article prepared from, the resin composition is higher. On the other hand, when the ratio of the weight of the ABS resin is 10% by weight or lower, the flame retardance of a molded article prepared from the resin composition is higher. From the viewpoints described above, the ratio of the weight of the ABS resin is more preferably from 5% by weight to 10% by weight.

### Phosphate

The resin composition according to the exemplary embodiment contains the phosphate (including a condensed phosphate).

Examples of the phosphate include trimethyl phosphate, triethyl phosphate, tributyl phosphate, tri(2-ethylhexyl)phosphate, tributoxyethyl phosphate, triphenyl phosphate, tricresyl phosphate, trixylenyl phosphate, tris(isopropylphenyl)phosphate, tris(phenylphenyl)phosphate, trinaphthyl phosphate, cresyldiphenyl phosphate, xylenyldiphenyl phosphate, diphanyl(2-ethylhexyl)phosphate, di(isopropylphenyl)phenyl phosphate, monoisodecyl phosphate, 2-acryloyloxy ethyl acid phosphate, 2-metharcyloyloxy ethyl acid phosphate, diphenyl-2-acryloyloxy ethyl phosphate, diphenyl-2-methacyloyloxy ethylphosphate, melamine phosphate, dimelamine phosphate, melamine pyrophosphate, triphenylphosphine oxide, tricresylphosphine oxide, diphenyl methanephosphonate, and diethyl phenylphosphonate.

Examples of the condensed phosphate include aromatic condensed phosphates of bisphenol A type, biphenylene type, isophthalic type, and the like. Specifically, for example, a condensed phosphate represented by the following formula (A) or a condensed phosphate represented by the following formula (B) may be used.

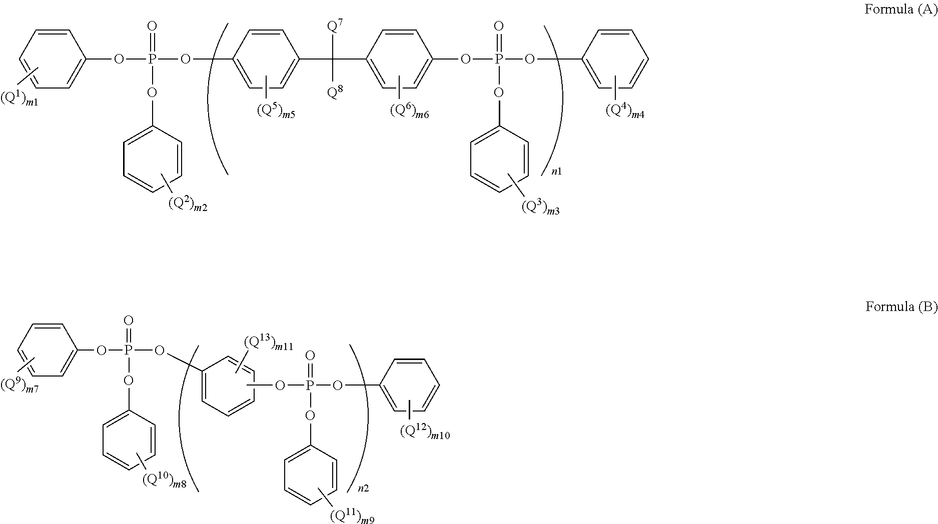

In the formula (A), Q¹, Q², Q³, and Q⁴ each independently represent an alkyl group having from 1 to 6 carbon atoms; Q⁵ and Q⁶ each independently represent a methyl group; Q⁷ and Q⁸ each independently represent a hydrogen atom or a methyl group; m1, m2, m3, and m4 each independently represent an integer of from 0 to 3; m5 and m6 each independently represent an integer of from 0 to 2; and n1 represents an integer of from 0 to 10.

In the formula (B), Q⁹, Q¹⁰, Q¹¹, and Q¹² each independently represent an alkyl group having from 1 to 6 carbon atoms; Q¹³ represents a methyl group; m7, m8, m9, and m10 each independently represent an integer of from 0 to 3; m11 represents an integer of from 0 to 4; and n2 represents an integer of from 0 to 10.

As the condensed phosphate, a synthetic product or a commercially available product may be used, examples of the commercially available product of the condensed phosphate include commercially available products manufactured by Daihachi Chemical Industry Co., Ltd. such as “PX200”, “PX201”, “PX202”, and “CR741”; and commercially available products manufactured by Adeka Corporation such as “ADK STAB FP2100” and “ADK STAB FP2200”.

A ratio of the weight of the phosphate to the total weight of the resin composition is preferably from 10% by weight to 30% by weight, when the ratio of the weight of the phosphate is 10% by weight or higher, the flame retardance of a molded article prepared from the resin composition is higher. When the ratio of the weight of the phosphate is 30% by weight or lower, the impact resistance of a molded article prepared from, the resin composition is higher. From, the above-described viewpoints, the ratio of the weight of the phosphate is more preferably from 15% by weight to 25% by weight.

### Polyester Polyol

The resin composition according to the exemplary embodiment may further contain a polyester polyol. By the resin composition containing the polyester polyol, the plasticity of the cellulose derivative is improved, and the moidabiiity of the resin composition is improved. The kind of the polyester polyol is not particularly limited, and a well-known polyester polyol of the related art may be used.

As the polyester polyol, for example, a condensate of a polybasic acid and a polyol may be used.

As the polybasic acid, for example, a polyvalent carboxylic acid may be used, and specific examples thereof include phahalic acid, isophthalic acid, tetrahydrophthalic acid, tetrahydroisophthalic acid, hexahydrophthalic acid, hexahydroterephthalic acid, trimellitic acid, adipic acid, sebacic acid, succinic acid, azelaic acid, fumaric acid, maleic acid, itaconic acid, pyromellitic acid, and acid anhydrides thereof.

As the polyol, glycol or a tri- or higher valent polyol may be used. Specific examples of the glycol include ethylene glycol, propylene glycol, diethylene glycol, triethylene glycol, tetraethylene glycol, dipropylene glycol, polyethylene glycol, polypropylene glycol, neopentyl glycol, hexylene glycol, 1,3-butanediol, 1,4-butanediol, 1,5-pentanediol, 1,6-hexanediol, 2-butyl-2-ehtyl -1,3-propanediol, methylpropanediol, cyclohexanedimethanol, and 3,3-diethyl-1,5-petanediol. Specific examples of the tri- or higher valent polyol include glycerin, trimethylolethane, trimethylolpropane, pentaerythritol, and dipentaerythritol.

The polybasic acids and the polyols may be used alone or in combination of two or more kinds, respectively.

The weight average molecular weight of the polyester polyol in terms of polystyrene is preferably from 1,000 to 4,000. When the weight average molecular weight is 1,000 or higher, a phenomenon of bleeding in which the polyester polyol bleeds out to the surface of the resin molded article is hard to occur. On the other hand, when the weight average molecular weight is 4,000 or lower, a plasticizing effect to the cellulose derivative is higher. From the above-described viewpoints, the weight average molecular weight is more preferably 1,000 to 3,500.

It is preferable that a hydroxyl value (mgKOH/g) of the polyester polyol be from 1.0 to 150. When the hydroxyl value is 10 or more, the affinity to the cellulose derivative is high, and the bleeding of the polyester polyol is hard to occur. On the other hand, when the hydroxyl value is 150 or lower, the fluidity of the resin composition is higher.

From the viewpoints of improving the impact resistance of a molded article prepared from the resin composition and suppressing bleeding, a ratio of the weight of the polyester polyol to the total weight of the resin composition is preferably from 1% by weight to 15% by weight, more preferably from 2% by weight to 10% by weight, and still more preferably 5% by weight to 10% by weight.

### Other Components

Optionally, the resin composition according to the exemplary embodiment may further contain other components in addition the above -described components. Example's of other components include a compatibiliser, a plasticiser, an antioxidant, a release agent, a light-res is cant agent, a weather-resistant agent, a colorant, a pigment, a modifier, a dripping inhibitor, an antistatic agent, an hydrolysis inhibitor, a filler, and a reinforcing agent (for example, glass fiber, carbon fiber, talc, clay, mica, glass flake, milled glass, glass bead, crystalline silica, alumina, silica nitride, alumina nitride, and boron nitride). The content of each of these components is preferably from 0% by weight to it by weight with respect to the total weight of the resin composition. “0% by weight” described herein represents the resin composition not containing other component.

The resin composition according to the exemplary embodiment may further contain other resins in addition to the cellulose derivative represented by the formula (1), the polycarbonate, and the ABS resin. In this case, the resin composition contains other resins in a range in which moldability is not decreased during molding using a molding machine.

As other resins, for example, a well-known thermoplastic resin of the related art may be used, and specific examples thereof include polypropylene resins; polyester resins; polyolefin resins; polyphenylene ether resins; polyphenylene sulfide resins; polysulfone resins; polyether sulfone resins; polyarylene resins; polyether laide resins; polyaoetal resins; polyvinyl acetal resins; polyketone resins; polyether ketone resins; polyether ether ketone resins; polyaryl ketone resins; polyether nitrite resins; liquid crystal resins; polybenzimidasole resins; polyparabanic acid resins; vinyl-based polymer or copolymer resins obtained by polymerization or copolymerization of one or more vinyl monomers selected from the group consisting of aromatic alkenyl compounds, methacrylates, acrylates, and vinyl cyanide compounds; disease-aromatic, alkenyl compound copolymer resins; vinyl cyanide-diene-aromatic alkenyl compound copolymer resins; aromatic alkenyl compound-diene-vinyl cyanide-N-phenylmaleimida copolymer resins; vinyl cyanide-(ethylene-diene-propylene (EPDM))-aromatic alkenyl compound copolymer resins; polyolefins; vinyl chloride resins; and chlorinated vinyl chloride resins. These resins may be used alone or in combination of two or more kinds.

The resin composition according to the exemplary embodiment may contain other flame retardants other than the phosphate. Other flame retardants are not particularly limited, and a well-known flame retardant of the related art may be used and examples thereof include a phosphorus-based flame retardant, a sulfuric acid-based flame retardant, a nitrogen-based flame retardant, an inorganic hydroxide-based flame retardant, a halogen-based flame retardant, and a silicone-based, flame retardant.

### Method of Preparing Resin Composition

The resin composition according to the exemplary embodiment is prepared by, for example, melt-kneading a mixture of the above-described, components. Alternatively, the resin composition according to the exemplary embodiment may be prepared, for example, by dissolving the above-described components in a solvent. As units for melt-kneading, for example, well-known units may be used and specific examples thereof include a twin screw extruder, a Henschel mixer, a Bunbury mixer, a single screw extruder, a multi -screw extruder, and a co-kneader.

### Resin Molded Article

A resin molded article according to an exemplary embodiment of the invention is prepared from the resin composition according to the exemplary embodiment. That is, the resin molded article according to the exemplary embodiment has the same configuration as the resin composition according to the exemplary embodiment.

Specifically, the resin molded article according to the exemplary embodiment is prepared by molding the resin composition according to the exemplary embodiment. Examples of a molding method used for the resin molded article include injection molding, extrusion molding, blow molding, hot press molding, calender molding, coating molding, cast molding, dipping molding, vacuum molding, and transfer molding.

As the molding method for the resin composition according to the exemplary embodiment, injection molding is preferably used from the viewpoint of high degree of freedom for the shape. Since the resin composition according to the exemplary embodiment has satisfactory fluidity, injection molding may be applied thereto. Injection molding may be performed using, for example, a commercially available apparatus such as NEX 150 manufactured by Hissei Plastic Industrial Co., Ltd., NEX 70000 manufactured by Missel Plastic Industrial Co., Ltd., and SE50D manufactured by TOSHIBA MACHINE CO., LTD.

The resin molded article according to the exemplary embodiment is suitably used for products which require both impact resistance and flame retardance, for example, electronic and electric equipment, business equipment, home electric appliances, automotive interior materials, and containers. Specific examples of the products include housings of electronic and electric equipment and home electric appliances; various parts of electronic and electric equipment and home electric appliances; automotive interior materials; storage cases for CD-ROM, DVD and the like; table ware; beverage bottles; food trays; wrapping materials; films; and sheets.

### EXAMPLES

Hereinafter, the invention will be described in more detail using examples but is not limited to these examples.

### Preparation of Resin Composition and Resin Molded Article Kneading

Materials are put info a twin screw kneader (TEX41SS manufactured by Toshiba Machine Co., Ltd.) in accordance with a composition shown in Table 1 and are kneaded at a cylinder temperature of 230° C. As a result, compositions 1 to 23 and C1 to C6 are prepared. In Table 1, numerical values are represented by parts by weight.

TABLE 1

| | (A) | | | | | | | | | | | | | | | | | | |
|---|---|---|---|---|---|---|---|---|---|---|---|---|---|---|---|---|---|---|---|
| | Cellulose | | | (B) | | | (C) | | | Flame Retardant | | | Polyester | | | | | | |
| | Derivative | | | Polycarbonate | | | ABS Resin | | | Phosphate | | Other | Polyol | | | | | (A) + (B)/ | |
| | 1 | 2 | 3 | 4 | 5 | 6 | 7 | 8 | 9 | 10 | 11 | 12 | 13 | 14 | 15 | (A)/(B) | (A)/(C) | (C) | Note |
| Composition 1 | 50 | | | 35 | | | 5 | | | 10 | | | | | | 1.43 | 10 | 17 | Example |
| Composition 2 | 50 | | | 30 | | | 5 | | | 10 | | | 5 | | | 1.67 | 10 | 16 | Example |
| Composition 3 | 50 | | | 20 | | | 10 | | | 10 | | | 10 | | | 2.5 | 5 | 7 | Example |
| Composition 4 | 50 | | | 20 | | | 12 | | | 10 | | | 8 | | | 2.5 | 4.17 | 5.83 | Example |
| Composition 5 | 50 | | | 20 | | | 4 | | | 20 | | | 6 | | | 2.5 | 12.5 | 17.5 | Example |
| Composition 6 | 60 | | | 20 | | | 2 | | | 8 | | | 10 | | | 3 | 30 | 40 | Example |
| Composition 7 | 60 | | | 20 | | | 2 | | | 10 | | | 8 | | | 3 | 30 | 40 | Example |
| Composition 8 | 85 | | | 3 | | | 2 | | | 10 | | | | | | 28.33 | 42.5 | 44 | Example |
| Composition 9 | 75 | | | 8 | | | 4 | | | 10 | | | 3 | | | 9.38 | 18.75 | 20.75 | Example |
| Composition 10 | 70 | | | 7 | | | 5 | | | 10 | | | 8 | | | 10 | 14 | 15.4 | Example |
| Composition 11 | 45 | | | 15 | | | 5 | | | 30 | | | 5 | | | 3 | 9 | 12 | Example |
| Composition 12 | 42 | | | 12 | | | 4 | | | 33 | | | 9 | | | 3.5 | 10.5 | 13.5 | Example |
| Composition 13 | 10 | | | 76 | | | 2 | | | 10 | | | 2 | | | 0.13 | 5 | 43 | Example |
| Composition 14 | 8 | | | 81 | | | 1 | | | 10 | | | | | | 0.099 | 8 | 89 | Example |
| Composition 15 | | 50 | | 20 | | | 10 | | | 10 | | | 10 | | | 2.5 | 5 | 7 | Example |
| Composition 16 | | | 50 | 20 | | | 10 | | | 10 | | | 10 | | | 2.5 | 5 | 7 | Example |
| Composition 17 | 50 | | | | 20 | | 10 | | | 10 | | | 10 | | | 2.5 | 5 | 7 | Example |
| Composition 18 | 50 | | | | | 20 | 10 | | | 10 | | | 10 | | | 2.5 | 5 | 7 | Example |
| Composition 19 | 50 | | | 20 | | | | 10 | | 10 | | | 10 | | | 2.5 | 5 | 7 | Example |
| Composition 20 | 50 | | | 20 | | | | | 10 | 10 | | | 10 | | | 2.5 | 5 | 7 | Example |
| Composition 21 | 50 | | | 20 | | | 10 | | | | 10 | | 10 | | | 2.5 | 5 | 7 | Example |
| Composition 22 | 50 | | | 20 | | | 10 | | | 10 | | | | 10 | | 2.5 | 5 | 7 | Example |
| Composition 23 | 50 | | | 20 | | | 10 | | | 10 | | | | | 10 | 2.5 | 5 | 7 | Example |
| Composition C1 | 60 | | | 20 | | | | | | 10 | | | 10 | | | 3 | — | — | Comparative |
| | | | | | | | | | | | | | | | | | | | Example |
| Composition C2 | 20 | | | 60 | | | | | | 10 | | | 10 | | | 0.33 | — | — | Comparative |
| | | | | | | | | | | | | | | | | | | | Example |
| Composition C3 | 70 | | | | | | 10 | | | 10 | | | 10 | | | — | 7 | 7 | Comparative |
| | | | | | | | | | | | | | | | | | | | Example |
| Composition C4 | 80 | | | | | | 5 | | | 10 | | | 5 | | | — | 16 | 16 | Comparative |
| | | | | | | | | | | | | | | | | | | | Example |
| Composition C5 | 50 | | | 20 | | | 10 | | | | | 10 | 10 | | | 2.5 | 5 | 7 | Comparative |
| | | | | | | | | | | | | | | | | | | | Example |
| Composition C6 | 40 | | | 20 | | | 5 | | | | | 30 | 5 | | | 2 | 8 | 12 | Comparative |
| | | | | | | | | | | | | | | | | | | | Example |

In Table 1, the kinds of the materials are as follows.

### Cellulose Derivative

Compound 1: acetyl cellulose, acetyl substitution degree: 2.42, weight average molecular weight; 120,000 (L-20, manufactured by Daicei Corporation)

Compound 2: acetyl cellulose, acetyl substitution degree: 2.56, weight average molecular weight: 180,000 (L-50, manufactured by Daicei Corporation)

Compound 3: cellulose acetate propionate, acetyl substitution degree: 1.95, propionyl substitution degree: 0.42, weight average molecular weight: 140,000 (CAP-482, manufactured by Eastman Chemical Company)

### Polycarbonate

Compound 4: PANLITE L1225Y manufactured by Teijin Ltd., weight average molecular weight; 22,000

Compound 5: PAMLITE L1225LM manufactured by Teijin Ltd., weight average molecular weight; 19,000

Compound 6: CALIBER 200 manufactured by Sumitomo Dow Co., Ltd., weight average molecular weight: 24,000

### ABS Resin

Compound 7: PA756S manufactured by Chimei Corporation, content of acrylonitrile: 40% by weight, content of butadiene: 15% by weight

Compound 8: AT05 manufactured by Daicei Corporation, content of acrylonitriie: 35% by weight, content of butadiene: 18% by weight

Compound 9: CLARASTICK GA704 manufactured by Nippon A&L Inc., content of acrylonitrile: 38% by weight, content of butadiene; 12% by weight.

### Flame Retardate

Compound 10; condensed phosphate (PX200 manufactured by Daihachi Chemical Industry Co., Ltd.)

Compound 11: condensed phosphate (CR741 manufactured by Daihachi Chemical Industry Co., Ltd.)

Compound 12: ammonium polyphosphate (Exolit AP422 manufactured by Clariant Japan K.K.)

### Polyester Polyol

Compound 13: ODX233 manufactured by DIC Corporation, weight average molecular weight; 1,000, hydroxyl value; 52 mgKOH/g

Compound 14: GDX2044 manufactured by DIC Corporation, weight average molecular weight: 2,000, hydroxyl value: 48 mgKOH/g

Compound 15: ODC2376 manufactured by SIC Corporation, weight average molecular weight; 3,700, hydroxyl value: 45 mgKOH/g

### Molding

The compositions 1 to 23 and C1 to C6 are put into an extrusion molding machine (HEX 150 manufactured by Nissei Plastic Industrial Co., Ltd.) and are kneaded at a cylinder temperature of 230° C. and a mold temperature of 40° C. As a result, an 150 multi-purpose dumbbell test specimen (in a test part, length; 100 mm, width; 10 mm, thickness; 4 mm) and a UL test specimen (length: 125 mm, width: 13 mm, thickness: 0.5 mm, 1.6 mm) are prepared from each of the compositions 1 to 23 and C1 to C6. The mold temperature is set to be low by water circulating around the inside of a mold.

### Evaluation

### Impact Resistance

The ISO muiti-purpose dumbbell, test specimen is processed according to ISO17 9, and Charpy notched impact strength (kJ/m²) thereof is measured using a digital impact resistance test apparatus (DZ-GI, manufactured by Toyo Seiki Seisaku-sho, Ltd.). The results are shown in Table 2.

### Flame Retardance

Using the OL test specimen, flame retardance is evaluated in a UL 94 V Test. The evaluation criteria are “V-0”, “V-1”, “V-2”, and “Not” in order from highest flame retardance. The results are shown in Table 2.

TABLE 2

| | |
|---|---|
| Charpy Impact | |
| Strength | Flame Retardance |

| | (kJ/m²⁾ | 1.6 mm | 0.5 mm |
|---|---|---|---|
| Composition 1 | 10.0 | V-0 | V-0 |
| Composition 2 | 9.5 | V-0 | V-0 |
| Composition 3 | 10.5 | V-0 | V-0 |
| Composition 4 | 11.5 | V-0 | V-2 |
| Composition 5 | 9.8 | V-0 | V-0 |
| Composition 6 | 8.2 | V-0 | V-2 |
| Composition 7 | 9.5 | V-0 | V-0 |
| Composition 8 | 9.2 | V-0 | V-0 |
| Composition 9 | 14.3 | V-0 | V-0 |
| Composition 10 | 10.8 | V-0 | V-2 |
| Composition 11 | 9.6 | V-0 | V-0 |
| Composition 12 | 7.2 | V-0 | V-0 |
| Composition 13 | 18.2 | V-0 | V-0 |
| Composition 14 | 11.5 | V-0 | V-2 |
| Composition 15 | 10.0 | V-0 | V-0 |
| Composition 18 | 8.4 | V-0 | V-2 |
| Composition 17 | 10.5 | V-0 | V-0 |
| Composition 18 | 9.9 | V-0 | V-0 |
| Composition 19 | 9.5 | V-0 | V-0 |
| Composition 20 | 9.8 | V-0 | V-0 |
| Composition 21 | 10.2 | V-0 | V-0 |
| Composition 22 | 11.0 | V-0 | V-0 |
| Composition 23 | 10.8 | V-0 | V-0 |
| Composition C1 | 3.5 | V-2 | Not |
| Composition C2 | 3.7 | V-2 | Not |
| Composition C3 | 3.2 | Not | Not |
| Composition C4 | 3.5 | Not | Not |
| Composition C5 | 8.5 | Not | Not |
| Composition C6 | 7.9 | Not | Not |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A resin composition comprising:
a cellulose derivative represented by the following formula (1);
a polycarbonate;
an ABS resin; and
a phosphate: 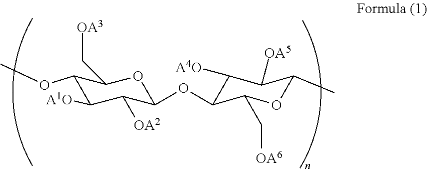
wherein A¹, A², A³, A⁴, A⁵, and A⁶ each independently represent a hydrogen atom or an acyl group, and n represents an arbitrary integer.

2. The resin composition according to claim 1,
wherein the cellulose derivative is an acetyl cellulose having an acetyl substitution degree of from 2.2 to 2.5.

3. The resin composition according to claim 1,
wherein a ratio of the weight of the cellulose derivative to the total weight of the resin composition is from 8% by weight to 35% by weight.

4. The resin composition according to claim 1,
wherein a ratio of the weight of the cellulose-derivative to the total weight of the resin composition is from 10% by weight to 80% by weight.

5. The resin composition according to claim 2,
wherein a ratio of the weight of the cellulose derivative to the total weight of the resin composition is from 8% by weight to 35% by weight.

6. The resin composition according to claim 2,
wherein a ratio of the weight of the cellulose derivative to the total, weight of the resin composition is from 10% by weight to 80% by weight.

7. The resin composition according to claim 1,
wherein a ratio of the weight of the phosphate to the total weight of the resin composition is from 10% by weight to 30% by weight.

8. The resin composition according to claim 1,
wherein a content ratio (cellulose derivative/polycarbonate, weight ratio) of the cellulose derivative to the polycarbonate is from 0.1 to 0.5 or from 2.3 to 15.

9. The resin composition- according to claim 1, further comprising
a polyester polyol having a weight average molecular weight of from 1,000 to 4,000.

10. A resin molded article comprising;
a cellulose derivative represented by the following formula (1);
a polycarbonate;
an ABS resin; and
a phosphate: 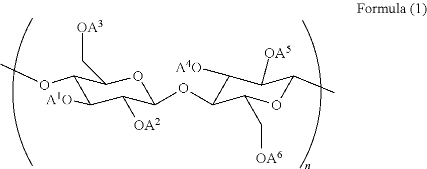
wherein A¹, A², A³, A⁴, A⁵, and A⁶ each independently represent a hydrogen atom or an acyl group, and n represents an arbitrary integer.

11. The resin molded article according to claim 10,
wherein the cellulose derivative is an acetyl cellulose having an acetyl substitution degree of from 2.2 to 2.5.

12. The resin molded article according to claim 10,
wherein a ratio of the weight of the cellulose derivative to the total weight of the resin molded article is from 3% by weight to 85% by weight.

13. The resin molded article according to claim 10,
wherein, a ratio of the weight of the cellulose derivative to the total weight of the resin molded article is from 10% by weight to 80% by weight.

14. The resin molded article according to claim 11,
wherein a ratio of the weight of the cellulose derivative to the total weight of the resin molded article is from 3% by weight to 85% by weight.

15. The resin molded, article according to claim 11,
wherein a ratio of the weight of the cellulose derivative to the total weight of the resin molded article is from 10% by weight to 80% by weight,

16. The resin molded article according to claim 10,
wherein a ratio of the weight of the phosphate to the total weight of the resin molded article is from 10% by weight to 30% by weight.

17. The resin molded article according to claim 10,
wherein a content ratio (cellulose derivative/polycarbonate, weight ratio) of the cellulose derivative to the polycarbonate is from 0.1 to 0.5 or from 2.3 to 15.

18. The resin molded article according to claim 10, further comprising
a polyester polyol having a weight average molecular weight, of from 1,000 to 4,000.
